(19) United States
(12) Patent Application Publication
(10) Pub. No.: US 2008/0190901 A1
(43) Pub. Date: Aug. 14, 2008

(54) Method and device for laser welding of a rim to the disk of a wheel for motor vehicles

(75) Inventor: Luigi Caprioglio, Rivoli (Torino) (IT)

Correspondence Address: NIXON & VANDERHYE, PC, 901 NORTH GLEBE ROAD, 11TH FLOOR, ARLINGTON, VA, 22203, US

(73) Assignee: Mussino S.r.I., Rivoli(Torino) (IT)

(21) Appl. No.: 12/068,761

(22) Filed: Feb. 11, 2008

(30) Foreign Application Priority Data
Feb. 14, 2007 (EP) 1 752 311

(51) Int. Cl. B23K 26/20

(52) U.S. Cl. 219/121.64; 219/121.63

(57) ABSTRACT

Described herein is a method for laser welding of a rim to the disk of a wheel for motor vehicles, in which the rim envisages a circumferential wall, with an internal surface, and the disk envisages a circumferential portion, which is in contact with said internal surface of the rim and has a circumferential end edge, said method comprising the operation of focusing the laser beam in the area of contact between the circumferential portion of the disk and the internal surface of the rim, in a position corresponding to the circumferential end edge of the disk.

### BACKGROUND OF THE INVENTION

The present invention relates to a method and a device for laser welding of a rim to the disk of a wheel for motor vehicles.

Wheels for motor vehicles, which in their most widespread version are made of steel plate, have now for many years been of a standardized type, albeit with slight differences. Schematically, the wheel is made up of two parts: a rim and a disk.

The rim, obtained by rolling a ring made of steel plate, in addition to holding the tyre must also guarantee air tightness, given the by now consolidated use of “tubeless” technology.

The disk is obtained starting from a plane disk made of steel plate. With subsequent pressing operations, the shape of the disk is obtained with the perforations for fitting to the hub and with the particular more or less complex bell shape.

The above two parts are pre-assembled and joined together by means of force fitting; in particular, the rim receives the disk within it.

At this point, the welding operation comes into play for consolidating the union of the two parts forming the wheel. The standard welding process is carried out by means of a process of arc welding with welding rod and protective gas.

The arc-welding technique is not without drawbacks that have led to the search for new welding techniques.

Arc welds are typically of good quality, but, on account of the oil normally present in the steel plates, there exists the possibility that large quantities of fumes are formed, which, in some cases, can induce a porosity of the steel plates to be welded that reduces the quality of the weld.

Arc welding produces a considerable amount of incandescent weld-pool splashes, which in many cases deposit on the wheel itself and must be removed by brushing.

In addition, a further drawback is represented by the fact that arc welding is very slow.

In order to obtain very short welding-cycle times it is customary to use four welding torches simultaneously in order to perform the four stretches of weld between the rim and the disk simultaneously.

Arc welding is carried out using a welding rod, and this entails stopping the machine every 15 to 20 minutes to clean the feed nozzle that gets dirtied by the weld-pool splashes (an operation that is performed using manually operated rotating brushes).

These stoppages of the production line tend to reduce the efficiency of the production line by at least 10%. Machines for arc welding involve a lot of maintenance and must be stopped every day, at the end of the processing cycle, to undergo careful cleaning operations.

The arc-welding technique moreover presents the problem of the rejects that must be repaired; this problem further reduces the efficiency and output of the production line.

Arc welding moreover involves application of heat, and this generates non-negligible geometrical deformations, especially for use on vehicles designed for high speeds.

When moving, the wheel is subject to fatigue; in arc welds there intrinsically exist internal stresses, which, when the welds are subjected to repeated stress cycles, tend to be released giving rise to a subsequent deformation of the wheel.

In order to overcome the above drawbacks, laser welding is being introduced into this field of applications.

As compared to arc welding, laser welding presents the following advantages:

the weld proves more homogeneous on account of the uniformity of the material (there is no filler material involved);

thermal deformations are absent since the application of heat is less than one tenth that involved in the case of arc welding;

weld-pool splashes are absent; in this case, no brushing operation is necessary;

there are no technical stoppages of the manufacturing process; in arc welding the cleanliness of the nozzles and the replacement of the welding rods involve stoppages;

the production process is noiseless, with fumes reduced by 10% with respect to arc welding; and

the working area is clean.

So far, to the knowledge of the present applicant, the methods of laser welding of wheels of motor vehicles that have been proposed envisage that the laser beam will be applied radially from the outside towards the inside of the rim (see, for example, the document No. U.S. Pat. No. 5,431,486).

The above welding process is easy to carry out, but continues to present some disadvantages.

The first disadvantage is represented by the fact that, in order to obtain a mechanically resistant weld in the fit between the rim and the disk, it is necessary to fuse a considerable amount of steel plate. In this type of welding there is required a considerable laser power in order to obtain reduced cycle times, or else it is necessary to use more than one laser source, with obvious additional costs. Also this solution presents the problem caused by the oil present in the welding area. At the moment when the laser beam penetrates into the welding area, there is a marked development of vapour. As it exits violently from the weld pool, this vapour produces dangerous porosities (see the U.S. Pat. No. 5,431,486).

### SUMMARY OF THE INVENTION

The purpose of the present invention is to provide a device and a method for laser welding of a rim to the disk of a wheel for motor vehicles so as to guarantee maximum reliability and precision of processing at a relatively low cost.

With a view to achieving said purposes, the subject of the present invention is a method for laser welding of a rim to the disk of a wheel for motor vehicles, in which the rim envisages a circumferential wall with an internal surface, and the disk envisages a circumferential portion, which is in contact with said internal surface of the rim and has a circumferential end edge, said method comprising the operation of focusing the laser beam in the area of contact between the circumferential portion of the disk and the internal surface of the rim, in a position corresponding to the circumferential end edge of the disk.

A further subject of the invention is a device for laser welding of a rim to the disk of a wheel for motor vehicles.

The type of welding proposed herein calls for a correct positioning of the laser beam on the area of joining between disk and rim and a good alignment of the two steel plates. In this case, the power required of the laser sources is clearly lower than the preceding case of radial welding from outside in so far as the entire penetration of the laser beam is useful for constructing the resistant section. In this type of welding, the laser beam coming into contact with the joint of the two steel plates vaporizes the oil present and then starts to fuse the metal, so that the formation of the gases anticipates fusion of the steel plates, and exit of the gases is free.

Further advantageous and preferred characteristics of the invention are specified in the dependent claims.

### BRIEF DESCRIPTION OF THE DRAWINGS

Said characteristics and advantages will be immediately understandable from the ensuing description with reference to the annexed plate of drawings, which are provided purely by way of non-limiting example and in which:

FIG. 1 is a partial perspective view of the radial weld from the outside according to the known art (U.S. Pat. No. 5,431,486);

FIG. 2 illustrates a partial perspective view of the weld according to the present invention;

FIGS. 3A, 3B, 3C, are schematic views of three particular cases of fitting between rim and disk; and

FIG. 4 is a partial perspective view of the device for laser welding according to the present invention.

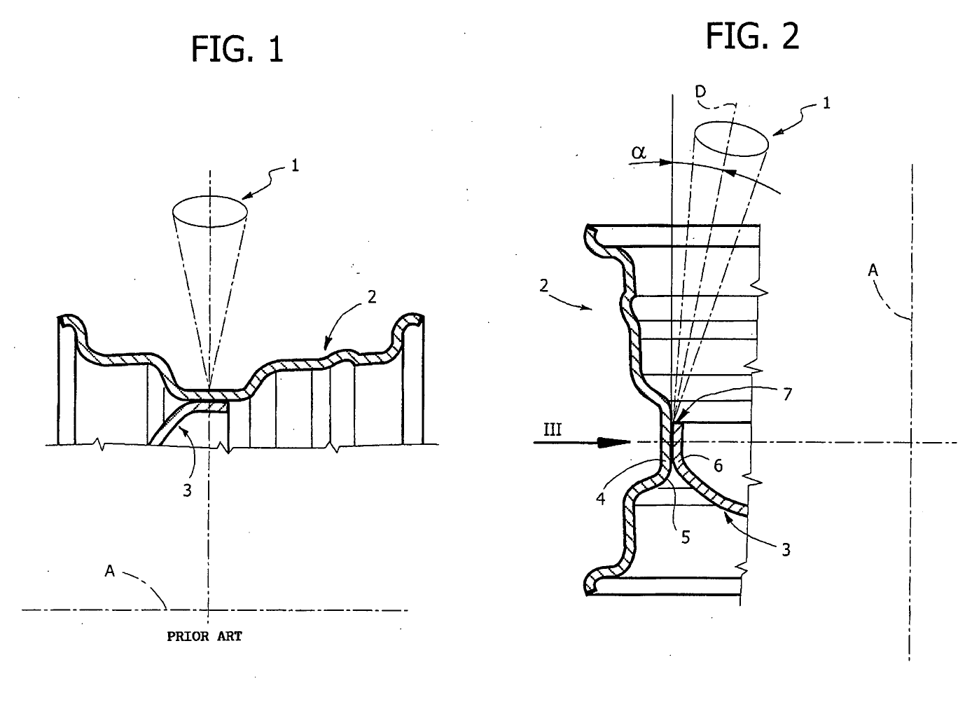

FIG. 1 illustrates a conventional technique of welding using a laser beam.

In particular, the laser beam 1 is applied in a radial direction from the outside towards the inside of a rim. Designated as a whole by the reference number 2 is a rim, and designated as a whole by the reference number 3 is a disk. In the example illustrated in FIG. 1, the laser beam 1 is applied in a direction perpendicular to the axis A of the wheel.

With reference to FIG. 2, which regards a preferred version of the invention, the laser beam 1 is applied in a substantially axial direction towards the inside of the rim.

The direction D of application of the laser beam 1 in this case forms an angle α with respect to a direction parallel to the axis A of the wheel, for example, in the region of 8°-10° and in any case sufficient for preventing any interference between the cone of the focused beam and the internal surface of the rim.

With reference to FIG. 2, the rim 2 envisages a circumferential wall 4 with an internal surface 5, and the disk 3 envisages a circumferential portion 6 in contact with the internal surface 5 of the rim 2. The circumferential portion 6 has a circumferential end edge 7.

With reference to FIG. 2 the laser beam 1 is focused, in the area of contact between the circumferential portion 6 of the disk 3 and the internal surface 5 of the rim 2, and in particular in a position corresponding to the circumferential end edge 7 of the disk 3.

The weld that is obtained is more homogeneous and requires a smaller power of the laser sources as compared to the prior art.

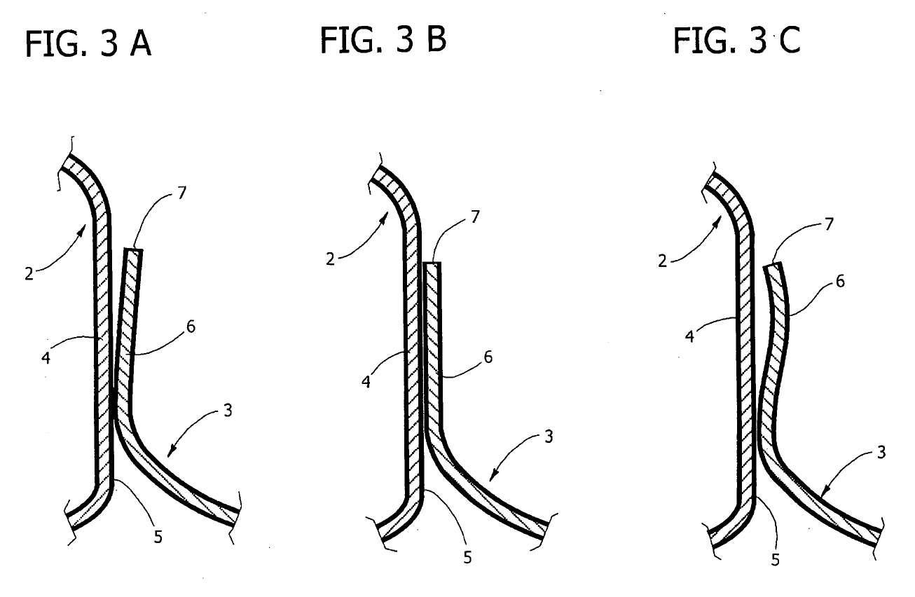

FIGS. 3A, 3B, and 3C present three possible conditions in which the area of contact, designated by III in FIG. 2, of the rim-disk structure may be found.

In particular, the condition of FIG. 3A arises in the case where the disk 3 does not come completely into contact with the rim 2. In particular, the circumferential portion 6 of the disk is not completely in contact with the internal surface 5 of the rim, and the circumferential end edge 7 is located at a distance from the internal wall 5 of the rim.

FIG. 3B illustrates the ideal case in which the circumferential portion 6 of the disk and the internal surface 5 of the rim mate completely.

Finally, illustrated in FIG. 3C is a situation in which the circumferential edge 6 of the disk has a deformation that keeps it at a distance from the internal surface 5 of the rim.

In the welding method according to the present invention of major importance is the operation of positioning of the laser beam 1 in the area of contact of the two steel plates.

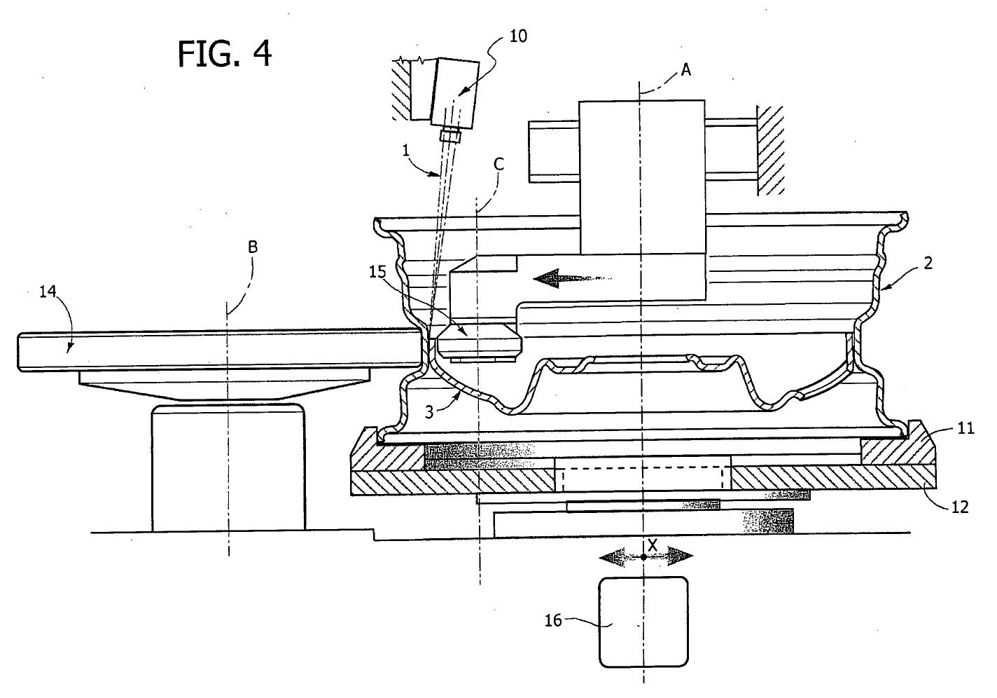

With reference to FIG. 4, the device according to the invention comprises: means 10 for focusing the laser beam 1; means 11 for supporting the structure to be welded constituted by the rim 2 with the disk 3 pre-assembled by force fitting within it; and means for imparting a relative movement between the structure to be welded and the focused laser beam 1.

A pair of counter-rotating wheels 14 and 15 engages, on opposite sides, the circumferential walls of the rim and disk fitted together.

In a preferred version, the means for imparting the relative motion between the structure to be welded and the focused laser beam comprise motor means 16 that control rotation of a rotating platform 12 on which the structure to be welded is mounted.

In a variant, the rotating platform 12 is free to turn, and the motor means are made up of the pair of counter-rotating wheels 14 and 15.

In any case, the first wheel 14 of the pair of counter-rotating wheels has one axis B fixed, and the second wheel 15 has an adjustable axis C that can be translated in a direction X perpendicular to the axis C of the second wheel, by means of actuator means of any type (not illustrated). Said actuator means are designed to press the wheel 15 against the wheel 14 with a force adequate for guaranteeing that any possible defects of the type illustrated in FIGS. 3A and 3C will be eliminated, bringing the steel plates back into the optimal configuration of FIG. 3B.

With reference to FIG. 4, both the fixed axis B and the adjustable axis C are parallel to the axis A of the wheel.

The wheel 15 enables compression of the area of contact between the circumferential portion 6 of the disk and the internal surface 5 of the rim in a position corresponding to the circumferential end edge 7 of the disk. The axis C of the wheel 15 can be regulated in the direction X to reduce to a minimum the deformations presented in FIGS. 3A and 3C.

The diameters of the wheels 14 and 15 are designed on the basis of Hertzian theory of concentrated contacts, in such a way that:

the wheel 14 does not introduce any thinning of the wheel rim (there is thus necessary a rather large diameter of the wheel 14); and

the wheel 15 will have a diameter as small as possible for creating the deformation necessary to the edge of the disk so as to cause it to mate perfectly with the rim (as illustrated in the case represented in FIG. 3B).

In any case, the structure, formed by the supporting means 11 and by the rotating platform 12, is mobile for the purposes of adapting the tolerances of the rim (ovality and tolerances of diameter).

Of course, without prejudice to the principle of the invention, the details of construction and the embodiments may vary widely with respect to what is described and illustrated herein purely by way of example, without thereby departing from the scope of the present invention.

What is claimed is:

1. A method for laser welding of a rim to the disk of a wheel for motor vehicles, in which:
said rim envisages a circumferential wall, with an internal surface; and
said disk envisages a circumferential portion, which is in contact with said internal surface of the rim, said circumferential portion having a circumferential end edge,
said method wherein it comprises the operation of focusing the laser beam in the area of contact between the circumferential portion of the disk and the internal surface of the rim, in a position corresponding to said circumferential end edge of the disk.

2. The method according to claim 1, wherein it envisages the operation of providing:
means for focusing the laser beam;
means for supporting the structure to be welded, constituted by the rim with the disk pre-assembled by force fitting within it; and
means for imparting a relative movement between the structure to be welded and the focused laser beam.

3. The method according to claim 2, wherein the means for imparting a relative movement between the structure to be welded and the focused laser beam are pre-arranged so as to comprise means for setting the structure to be welded in rotation about the axis of the wheel.

4. The method according to claim 3, wherein the means for supporting the structure to be welded are pre-arranged so as to comprise at least one pair of counter-rotating wheels, which engage, on opposite sides, the circumferential wall of the rim.

5. The method according to claim 3, wherein the means for imparting a relative movement between the structure to be welded and the focused laser beam are pre-arranged so as to comprise motor means that control rotation of a rotating platform on which the structure to be welded is to be mounted.

6. The method according to claim 4, wherein it comprises the operation of providing a freely rotating platform, on which the structure to be welded is to be mounted, and the motor means are pre-arranged so as to be made up of said at least one pair of counter-rotating wheels.

7. The method according to claim 4, wherein it comprises the operations of:
providing a first wheel of said pair of counter-rotating wheels with a fixed axis, and a second wheel with an adjustable axis that can be translated in a direction, perpendicular to the axis of the second wheel; and
providing actuator means designed to press the second wheel against the first wheel in order to eliminate any possible faulty positioning of the parts to be welded.

8. A device for laser welding a rim to a disk of a wheel for motor vehicles, in which:
said rim envisages a circumferential wall, with an internal surface; and
said disk envisages a circumferential portion, which is in contact with said internal surface of the rim and has a circumferential end edge,
said device wherein it comprises means for focusing the laser beam in the area of contact between the circumferential portion of the disk and the internal surface of the rim, in a position corresponding to said circumferential end edge of the disk.

9. The device according to claim 8, wherein the means for focusing the laser beam comprise:
means for focusing the laser beam;
means for supporting the structure to be welded, constituted by the rim with the disk pre-assembled by force fitting within it; and
means for imparting a relative movement between the structure to be welded and the focused laser beam.

10. The device according to claim 9, wherein the means for imparting a relative movement between the structure to be welded and the focused laser beam comprise means for setting the structure to be welded in rotation about the axis of the wheel.

11. The device according to claim 9, wherein the means for supporting the structure to be welded comprise at least one pair of counter-rotating wheels, which engage, on opposite sides, the circumferential wall of the rim.

12. The device according to claim 10, wherein the means for imparting a relative movement between the structure to be welded and the focused laser beam comprise motor means that control rotation of a rotating platform, on which the structure to be welded is to be mounted.

13. The device according to claim 11, wherein the device comprises a freely rotating platform, on which the structure to be welded is to be mounted, and in that the motor means are made up of said at least one pair of counter-rotating wheels.

14. The device according to claim 11, wherein a first wheel of said pair of counter-rotating wheels has a fixed axis, and a second wheel has an adjustable axis that can be translated in a direction, perpendicular to the axis of the second wheel, via actuator means designed to press the second wheel against the first wheel with a force sufficient for eliminating any possible faulty positioning of the parts to be welded.
